(19) United States
(12) Patent Application Publication
(10) Pub. No.: US 2022/0143767 A1
(43) Pub. Date: May 12, 2022

(54) Tool Changing Method For Machine Tool and Tool Changing Apparatus Thereof

(71) Applicant: Deta International Co., Ltd., Taichung City 429 (TW)

(72) Inventor: Shih-Tsung Huang, Taichung City (TW)

(21) Appl. No.: 17/091,497

(22) Filed: Nov. 6, 2020

(51) Int. Cl. B23Q 3/157; B23Q 3/155

(52) U.S. Cl. CPC B23Q 3/15713; B23Q 2003/155404; B23Q 3/1554

(57) ABSTRACT

The present invention reveals a tool changing method for machine tool and the apparatus thereof. The machine tool has a tool releasement detector disposed beside the spindle or the tool releasement apparatus. When the tool releasement apparatus hits the spindle to loose the clamp for tool releasement, the tool releasement detector generates a releasement signal. When the tool releasement apparatus resets and leaves the spindle, the tool releasement detector produces no signal. The tool changing apparatus is activated according the appearance of the releasement signal for changing the tool, activated according the disappearing of the releasement signal for declining from the spindle. Therefore, the tool changing apparatus can be operated timely and speedily, improving tool changing efficiency.

### FIELD OF THE INVENTION

The present disclosure relates to a tool changing method to change tools on the machine tool.

### BACKGROUND OF THE INVENTION

A tool for processing in a machine tool is often replaced according to the different processes, materials of workpieces, shapes of products, and the lifetime of the tools. Thus, a tool changing apparatus is necessary to the machine tool. For example, patent TW 1651155 showed the structure of the tool changing apparatus and the machine tool, and patents TW 1488709 and TW M458268 disclosed the process of tool changing.

In the disclosures mentioned above, the process of steps of tool changing includes tool releasement, tool gripping, tool changing, and tool insertion. In the step of tool releasement, the pulling rod at the rear end of the spindle is hit or pushed by a tool releasement apparatus to make the spindle release the tool. In the step of tool gripping, the tool changing apparatus clamps the tool released from the spindle and the tool for replacement in the magazine and moves the tools away from the spindle and the magazine. In the step of tool changing, the tool changing apparatus rotates to exchange the positions of the tools. In the step of tool insertion, the tool changing apparatus inserts the tools into the spindle and the magazine, and the spindle and the magazine clamp the tools. And then the tool changing apparatus is restored to the standby position.

To prevent the tools from hitting the machine or falling down, all the devices have to be in cooperation with each other. To ensure the correct operation, a signal plate can be installed in the tool changing apparatus to detect the angular position of the input axle or the output axle of the transmission device in order to correspond to the time of activation of the tool releasement apparatus to establish the order of process. Relative prior arts are shown in the paragraph of prior arts and FIGS. 7 and 8 of patent TW M518604, or patents TW 1317312 and TW M458268.

In addition, patent TW M518604 further disclosed that the encoder detects the angle and the position of the output axle of the tool changing apparatus. The process of tool changing apparatus can be controlled electrically.

### SUMMARY OF THE INVENTION

When controlling the process order of the tool changing apparatus mechanically or electrically, the angle and the position of the output axle, the activation or the braking of the motor in the tool changing apparatus, and releasement and restoration of the tool releasement apparatus have to be controlled respectively. The time to activate or to reach the desired position is affected by the hysteresis of the pneumatic device or the hydraulic devices, the differences of the members, the abrasion, or the elastic fatigue. If there is deviation, even slightly, abrasion, hitting the machine, or tool falling down may happen. Thus, the machine tool may be stopped, need more maintenance, or cause the tool damaging to increase the cost.

To prevent from the irregular operation order, please refer to FIG. 1, the operation order can be controlled by the signal sensing plate when controlling the tool changing apparatus and the tool releasement apparatus. The typical signal sensing plate includes a braking signal plate 91, a checking signal plate 92, and an origin signal plate 93. The braking signal plate 91 has a braking signal originally. The tool changing apparatus brakes and shuts down the motor. When the user switches on, the tool changing apparatus receives an activation signal, and the tool changing apparatus shuts down in the braking apparatus to activate the motor. The output axle of the tool changing apparatus operates following the timing diagram 94. When the braking signal plate 91 receives the second time of braking signal, the tool changing apparatus brakes, shuts down the motor, and triggers the tool releasement apparatus to release the tool. When the tool releasement apparatus sends the signal of releasement completed, the tool changing apparatus shuts down the braking apparatus and activates the motor to trigger the output axle to operate. When the braking signal plate 91 receives the third time of braking signal, the tool changing apparatus brakes, shuts down the motor, and triggers the tool clamped apparatus to clamp the tool. When the tool clamped apparatus sends a signal of tool clamped, the tool changing apparatus shuts down the braking apparatus again and activates the motor to trigger the output axle to operate in order to restore the tool changing apparatus. At the second time and the third time of braking signal, the tool changing apparatus may slide forward due to the inertia, and the tool clamped apparatus may delay due to the abrasion or the aging of the machine. Thus, the tool changing apparatus may move forward when the operation of the tool clamped apparatus is not completed yet to make the tool hit the machine or fall down. A tool releasement signal 921 can be set by the checking signal plate 92, and a releasement check point 922 can be defined as the moment that the tool releasement signal 921 ends. If the signal that the tool releasement apparatus completed the releasement is not received during the period of the tool releasement signal 921 or before the releasement check point 922, it means that the releasement is not completed normally. Thus, the machine is stopped with alarm. The tool changing apparatus shuts down the braking apparatus and activates the motor to rotate for exchanging the tools when received the signal of releasement completed. Thus, collision caused by the rotation of the tool changing apparatus before releasing the tools can be prevented. Besides, a tool clamped signal 923 can be set by the checking signal plate 92, and a clamped check point 924 is defined as a moment that the tool clamped signal 923 ends. If the signal that the tool releasement apparatus completed clamping is not received during the period of the tool clamped signal 923 or before the clamped check point 924, it means that the clamping is not completed normally. Thus, the machine is stopped with alarm. The tool changing apparatus shuts down the braking apparatus, activates the motor, and rotates for restoration when received the signal of completing clamping. Thereby, the tool is prevented from falling down caused by the restoration of the tool changing apparatus before the spindle have clamped the tool. The signal of releasement completed and the signal of completing clamping can be processed by the first sensing portion and the second sensing portion of the patent TW M458268. When tool releasement apparatus is higher, it means that the tool releasement apparatus has restored upward, so the step of clamping is completed. When the tool releasement apparatus is lower, it means that the tool releasement apparatus has moved downward, and the step of tool releasement is completed.

Due to the releasement check point 922 and the clamped check point 924 of the checking signal plate 92, it takes longer time to complete the releasement and clamping when the spring of the spindle loses elasticity, the machine abraded to enlarge the gaps, or hysteresis happens. If the tool changing apparatus slides, and the spindle completes releasement and clamping over the releasement check point and the clamped check point, the machine tool has to be stopped with alarm.

However, the time for releasement or clamping may change. When the speed of releasement and clamping is higher, the tool changing apparatus still has to wait for the signals of releasement completed and completing clamping to further shut down the braking apparatus to activate the motor. Thus, it is time-consuming. In a normal state, the time of tool changing is about 2-2.5 seconds.

In conclusion, the tool changing apparatus is limited by the operation order mentioned above, so the minimum time of tool changing cannot be further shortened. Thus, one of the purposes of the present invention is to provide a tool changing method which is able to keep the machine to operate smoothly and to shorten the time of tool changing without abrasion, tool hitting the machine, and tool falling down.

To achieve the above and other objects, the present invention provide a tool changing method for machine tool adapted for changing tools on a machine tool. The machine tool includes a spindle, an unclamp apparatus, a tool releasement detector, and a tool changing apparatus. The unclamp apparatus has a releasement position and a clamped position. When the tool releasement apparatus is at the releasement position, the spindle releases a tool. One of the tool releasement apparatus and the spindle is detected by the releasement detector so that the releasement detector sends a releasement signal. When the tool releasement apparatus is at the clamped position, the spindle clamps the tool. The releasement signal disappears. The tool changing method for machine tool includes moving the tool releasement apparatus to the releasement position, taking tools from the spindle and a magazine by the tool changing apparatus, exchanging positions of the tools, inserting one of the tool into the spindle, and moving the tool releasement apparatus to the clamped position.

In the method mentioned above, activate the tool changing apparatus according to the disappearance of the releasement signal after inserting the tool into the spindle and moving the tool releasement apparatus to the clamped position, or according to the appearance of the releasement signal after the tool releasement apparatus moves to the releasement position.

The present invention also provides a tool changing apparatus used in the tool changing method for machine tool mentioned above. The tool changing apparatus includes a power source, a transmission mechanism, a tool changing arm, and an encoder. The transmission mechanism has an output axle. The transmission mechanism is driven by the power source to make the output axle to rotate and to move following a specific operation order repeatedly. The tool changing arm is disposed on the output axle and is rotatable and movable following the output axle. The encoder is disposed on one of the power source and the transmission mechanism to detect a current position of the output axle in the specific operation order.

In the tool changing apparatus mentioned above, the power source can be a low inertia motor, and the transmission mechanism can be a cam-worm assembly.

Thereby, the braking apparatus can be shut down and the tool changing apparatus can be activated to rotate when the releasement signal appears. Thus, the time to wait for the releasement check point or the releasement check point can be saved, and the speed of tool changing can be increased.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

The present disclosure can be more fully understood by reading the following detailed description of the embodiment, with reference made to the accompanying drawings as follows:

FIG. 1 is an illustration of timing diagram of a prior art when

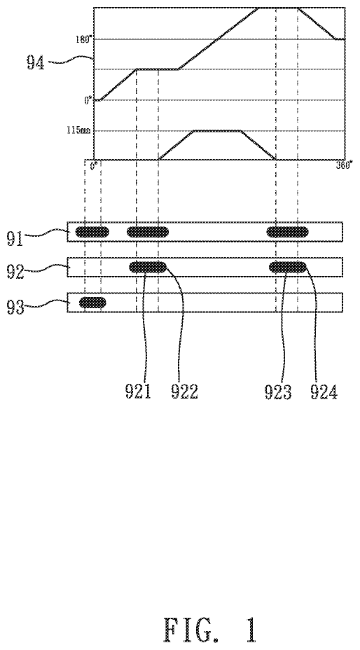

FIG. 2 is an illustration showing a machine tool suitable for a tool changing method for machine tool of the present invention;

FIG. 3 is a flow chart of a tool changing method for machine tool of the present invention.

### DETAILED DESCRIPTION OF THE PREFERRED EMBODIMENTS

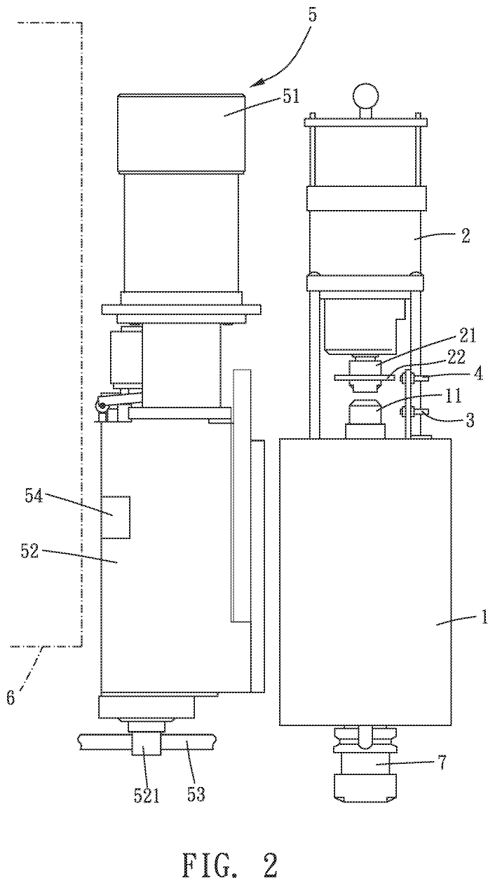

The present invention provides a tool changing method for machine tool, adapted for changing tools on a machine tool. Pleaser refer to FIG. 2, the machine tool includes a spindle 1, a tool releasement apparatus 2, a releasement detector 3, a clamped detector 4, a tool changing apparatus 5, and a magazine 6.

The spindle 1 is an output spindle of the machine tool, such as the spindle disclosed in patent TW 1418424. The spindle 1 has a pulling rod 11. The spindle 1 has a spring or other devices for restoration to push the pulling rod 11 upward. The spindle 1 is adapted for clamping a tool 7 for processing. When the pulling rod 11 is hit or pushed to move downward, the spindle 1 releases the tool 7.

The tool releasement apparatus 2 is arranged above the spindle 1. The tool releasement apparatus 2 has a pushing rod 21 which is movable up and down. The position of the pushing rod 21 corresponds to the pulling rod 11 of the spindle 1. When the pushing rod 21 moves downward a releasement position, the pushing rod 21 hits or pushes the pulling rod 11 to move downward to make the spindle 1 to release the tool 7. When the pushing rod 21 moves upward back to the clamped position, the pushing rod 21 releases and leaves the pulling rod 11 to make the spindle 1 to clamp the tool 7 again. Thereby, the pushing rod 21 can control the spindle 1 to clamp or to release the tool 7. Specifically, the too releasement apparatus 2 can be the structures disclosed in patents TW M458268, TW 465421, and TW 375213. The tool releasement apparatus 2 can have a sensing member 22 disposed on the pushing rod 21 to move up and down following the pushing rod 21. In other possible embodiments, the sensing member can be disposed on the pulling rod, the spindle, or other positions in the tool releasement apparatus to move up and down to achieve the same goal.

The releasement detector 3 and the clamped detector 4 are disposed on the spindle 1 or the tool releasement apparatus 2. The releasement detector 3 and the clamped detector 4 are located beside the sensing member 22 respectively and face the sensing member 22. When the pushing rod 21 moves downward to the releasement position, the sensing member 22 moves downward toward the releasement detector 3 to be located in front of the releasement detector 3. The releasement detector 3 detects the sensing member 22 to send a releasement signal. Thereby, the tool is completely released by the spindle. When the pushing rod 21 moves upward to the clamped position, the sensing member 22 moves upward to leave the releasement detector 3 and to be located in front of the clamped detector 4. The releasement detector 3 stops sending a releasement signal, and the clamped detector 4 detects the sensing member 22 to send a clamped signal. Thereby, the spindle is completely restored to clamp the tool.

The tool changing apparatus 5 is adapted for taking tools from the spindle 1 and the magazine 6, rotating to exchange the positions of the two tools, and inserting the tools into the spindle and the magazine. Specifically, the too changing apparatus 5 includes a power source 51, a transmission mechanism 52, a tool changing arm 53, and an encoder 54. The power source 51 can be a motor, preferably a low inertia motor to prevent the deviation caused by the motor inertia when the motor is activated or shut down. The transmission mechanism 52 can be a cam-worm assembly to connect to the power source directly or via the reducer. The transmission mechanism 52 has an output axle 521, and the tool changing arm 53 is disposed on the output axle 521. The transmission mechanism 52 is driven by the power source so that the output axle 521 triggers the tool changing arm 53 to rotate or move for exchanging tools 7 between the spindle 1 and the magazine 6. The transmission mechanism 52 can has a structure such as those disclosed in patents TW 1317312, TW 338014, and TW M458268. The encoder 54 is connected to the output axle 521 of the transmission mechanism 52 or other members in the transmission mechanism 52 so as to directly or indirectly detect the current position of the output axle 521 and to send position signal according to the position of the output axle 521. Because the power source 51 is connected to the transmission mechanism 52, the angular position of the power source 51 is related to the position of the output axle 521. Thus, in other possible embodiments, the encoder can be disposed on the power source to indirectly detect the current position of the output axle to send the position signal.

The magazine 6 can be a drum type magazine to provide tools to the tool changing apparatus 5 for changing tools. For example, the magazines disclosed in patents TW 445919, TW 1310715, and TW M565626 are suitable in the present invention. However, other types of magazine can be used if the magazine has appropriate size and position.

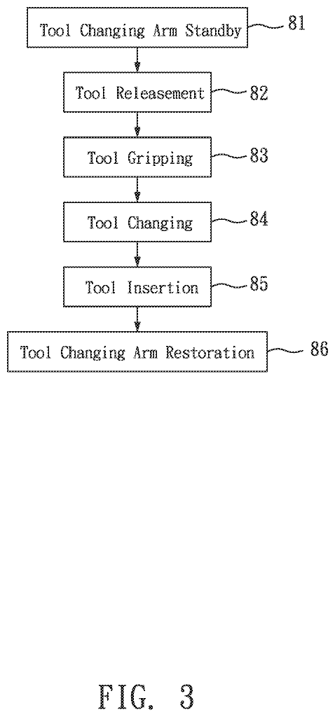

The tool changing method for machine tool of the present invention can be applied in the machine tool mentioned above. Please refer to FIG. 2 and FIG. 3, the tool changing method for machine tool includes standby step of tool changing arm, step of tool releasement, step of tool gripping, step of tool changing, step of tool insertion, and restoration step of tool changing arm. In the standby step of tool changing arm 81, activate the tool changing apparatus and rotate the tool changing arm 53 to make the two ends thereof located below the magazine 6 and the spindle 1 respectively. And then, shut down the tool changing apparatus and activate the braking apparatus. The tool changing arm 53 below the magazine 6 and the spindle 1 waits for other signals. In the step of tool releasement 82, activate the tool releasement apparatus 2 to move the pushing rod 21 downward to hit or push the pulling rod 11 of the spindle so that the spindle 1 releases the tool 7. After the pushing rod 21 has been moved, the releasement detector 3 detects the sensing member 22 to send the releasement signal. Specifically, the tool releasement apparatus 2 can be activated in advance before the tool changing arm 53 reaches the position below the spindle 1 and before the braking apparatus of the tool changing apparatus 5 is activated so that the tool is released quickly. In the step of tool gripping 83, shut down the braking apparatus and activate the tool changing apparatus 5 when the releasement signal appears, and drive the tool changing apparatus 5 to clamp the tool 7 released from the spindle 1 and the tool for replacement in the magazine 6 and to move the tools downward to leave the spindle 1 and the magazine 6. Specifically, the tool changing apparatus 5 is activated by activating the power source 51. In other words, activate the motor. In the step of tool changing 84, the tool changing apparatus drives the tools to rotate to exchange the positions of the tools from the magazine 6 and from the spindle 1. In the step of tool insertion 85, the tool changing apparatus 5 moves the tools 7 to insert them into the spindle 1 and the magazine 6. And then, shut the tool changing apparatus down and activate the braking apparatus. The tool releasement apparatus 2 drives the pushing rod 21 to move upward to leave the pulling rod 11 so that the pulling rod 11 is restored. Thus, the spindle 1 clamps the tool 7. After the pushing rod 21 is moved upward, the sensing member 22 leaves the releasement detector 3 to make the releasement signal disappear. Thereafter, the clamped detector 4 detects the sensing member 22 to send the clamped signal. In the restoration step of the too changing arm 86, shut down the braking apparatus and activate the tool changing apparatus 5 when the releasement signal disappears. The tool changing arm 53 is driven to move back to the standby position. The process is then ended.

In the process mentioned above, the appearance of the releasement signal means that the tool releasement apparatus has moved to the releasement position, that the pulling rod has moved downward, and that the spindle has released the tool. In the step of tool gripping, the braking apparatus is shut down and the tool changing apparatus is activated when the releasement signal appears. That is, the tool changing apparatus grips the tool to move at the moment that the tool is released to save time. In addition, the members connect correctly during the tool's transferring, so the efficiency of tool changing is improved. Also, the tool is prevented from hitting the machine or falling down.

In the process mentioned above, the disappearance of the releasement signal means that the tool releasement apparatus has leaved the releasement position, and the pulling rod is pushed by the restoration device in the spindle to move upward so as to clamp the tool. In the step of tool changing arm restoration, the braking apparatus is shut down and the tool changing device is activated at the moment that the releasement signal disappears, and the tool changing arm is moved to restore at the moment that the spindle clamps the tool. Thus, the time that moving the tool releasement apparatus to the releasement position and the time that confirming the spindle clamping the tool can be saved, so the efficiency is improved. The tool is held by the spindle due to the upward restoration at the moment that the tool enters the spindle, so the tool is prevented from falling down even if the speed of tool changing is raised.

Besides, the tool releasement apparatus can be activated in advance before the tool changing arm reaches the position below the spindle in 0.1-0.4 seconds. That is, at the moment that the tool releasement apparatus starts to move toward the releasement position, the tool is not clamped by the tool changing apparatus yet. The tool is released almost at the moment that the tool changing arm reaches the spindle. Thus, time is saved, and the time to brake and to shut the power source down is shortened. The inertia hysteresis caused by the shutting down and activating of the motor can be reduced so that the efficiency is improved.

It is noted that the direction “upward” and “downward” are used to define the relative positions of the members in the present embodiment. Thus, the structure having reversed or modified arrangement is also a possible embodiment of the present invention.

In conclusion, the tool changing apparatus can be activated early to shorten the time of tool changing to 1.26-1.34 seconds. Compared to that the time of tool changing in prior arts is about 2-2.5 seconds, it is advantageous that the time of tool changing of the present invention can save 33%-49% of time.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A tool changing method for machine tool, adapted for changing tools on a machine tool, the machine tool including a spindle, an unclamp apparatus, a tool releasement detector, and a tool changing apparatus, the unclamp apparatus having a releasement position and a clamped position; when the tool releasement apparatus is at the releasement position, the spindle releasing a tool, one of the tool releasement apparatus and the spindle is detected by the releasement detector so that the releasement detector sends a releasement signal; when the tool releasement apparatus is at the clamped position, the spindle clamping the tool, the releasement signal disappearing; the tool changing method for machine tool including moving the tool releasement apparatus to the releasement position, taking tools from the spindle and a magazine by the tool changing apparatus, exchanging positions of the tools, inserting one of the tool into the spindle, and moving the tool releasement apparatus to the clamped position, characterized by:
activating the tool changing apparatus according to the disappearance of the releasement signal after inserting the tool into the spindle and moving the tool releasement apparatus to the clamped position.

2. The tool changing method for machine tool of claim 1, wherein the tool changing apparatus is activated according to the appearance of the releasement signal after the tool releasement apparatus moves to the releasement position.

3. The tool changing method for machine tool of claim 1, wherein the tool changing apparatus doesn't clamp the tool inserted in the spindle at a moment that the tool releasement apparatus is going to move toward the releasement position.

4. The tool changing method for machine tool of claim 2, wherein the tool changing apparatus doesn't clamp the tool inserted in the spindle at a moment that the tool releasement apparatus is going to move toward the releasement position.

5. A tool changing method for machine tool, adapted for changing tools on a machine tool, the machine tool including a spindle, an unclamp apparatus, a tool releasement detector, and a tool changing apparatus, the unclamp apparatus having a releasement position and a clamped position; when the tool releasement apparatus is at the releasement position, the spindle being able to release a tool; when the tool releasement apparatus is at the clamped position, the spindle being able to grasp the tool; the tool changing method for machine tool including moving the tool releasement apparatus to the releasement position, taking tools from the spindle and a magazine by the tool changing apparatus, exchanging positions of the tools, inserting one of the tool into the spindle, and moving the tool releasement apparatus to the clamped position, characterized by:
the tool changing apparatus not clamping the tool inserted in the spindle at a moment that the tool releasement apparatus is going to move toward the releasement position.

6. The tool changing method for machine tool of claim 5, wherein the tool changing apparatus is activated according to the appearance of the releasement signal after the tool releasement apparatus moves to the releasement position.

7. A tool changing apparatus, used in the tool changing method for machine tool of claim 1, including:
a power source;
a transmission mechanism, having an output axle, the transmission mechanism being driven by the power source to make the output axle to rotate and to move following a specific operation order repeatedly;
a tool changing arm, disposed on the output axle and being rotatable and movable following the output axle;
an encoder, disposed on one of the power source and the transmission mechanism to detect a current position of the output axle in the specific operation order.

8. The tool changing apparatus of claim 7, wherein the power source is a lower inertia motor.

9. The tool changing apparatus of claim 7, wherein the transmission mechanism is a cam-worm assembly.

10. A tool changing apparatus, used in the tool changing method for machine tool of claim 5, including:
a power source;
a transmission mechanism, having an output axle, the transmission mechanism being driven by the power source to make the output axle to rotate and to move following a specific operation order repeatedly;
a tool changing arm, disposed on the output axle and being rotatable and movable following the output axle;
an encoder, disposed on one of the power source and the transmission mechanism to detect a current position of the output axle in the specific operation order.

11. The tool changing apparatus of claim 7, wherein the power source is a lower inertia motor.

12. The tool changing apparatus of claim 7, wherein the transmission mechanism is a cam-worm assembly.
